(19) United States
(12) Patent Application Publication
(10) Pub. No.: US 2013/0008064 A1
(43) Pub. Date: Jan. 10, 2013

(54) INFLATABLE SIGNBOARD

(76) Inventor: Jung Hui Park, Gokseong-gun (KR)

(21) Appl. No.: 13/635,702

(22) PCT Filed: May 17, 2010
(86) PCT No.: PCT/KR2010/003097

§ 371 Date: Sep. 18, 2012

(30) Foreign Application Priority Data
Mar. 20, 2010 (KR) 10-2010-0024987

(51) Int. Cl. G09F 15/00

(52) U.S. Cl. 40/603

(57) ABSTRACT

An inflatable signboard capable of easily coupling an inflatable pillar includes a support which is put on the ground and a coupling bar which is a coupling medium positioned between the support and an inflatable pillar erected on the upper part of the support, wherein a pillar insertion groove into which the inflatable pillar is capable of being inserted is formed on an upper surface of the coupling bar, a gap of the pillar insertion groove is filled with a wooden lath, and the coupling bar, the wooden lath, and the inflatable pillar are penetrated and fixed simultaneously through a plurality of fixing pieces, thereby coupling the inflatable pillar easily.

### CROSS REFERENCE TO RELATED APPLICATIONS AND CLAIM OF PRIORITY

This patent application is a National Phase application under 35 U.S.C. §371 of International Application No. PCT/KR2010/003097, filed May 17, 2010, entitled AIR SIGNBOARD CAPABLE OF EASILY COUPLING AIR PILLAR, which claims priority to Korean Patent Application number 10-2010-0024987, filed on May 20, 2010, entire contents of which are incorporated herein by reference.

### BACKGROUND

1. Field of Invention

The present invention relates generally to an inflatable signboard capable of coupling an air pillar.

2. Description of the Related Art

Recently, inflatable signboards have been widely used for advertisement. FIG. 1 shows a conventional inflatable signboard.

Referring to FIG. 1, an inflatable signboard includes a support 1 and an air pillar 2. The air pillar 2 is made of flexible materials, formed in tube type, and a lower part of the air pillar 2 is coupled to the support 1 in order that the air pillar 2 is expanded with a pillar shape by inflowed air pressure to be erected.

A blower (not shown) for injecting air into the air pillar 2 and a lighting device (not shown) for irradiating light into the air pillar 2 are mounted in the support 1.

In addition, in order to couple the air pillar 2 to the support 1, after the lower part of the air pillar 2 engages with an upper part of the support 1, ⊂-shaped iron pins are driven in a circumference of a lower part of the air pillar 2 at a predetermined interval to fix the air pillar 2 to the support 1 in a conventional manner.

However, since ⊂-shaped iron pins should be driven at narrow interval to firmly fix the air pillar 2 to the support 1, there are disadvantages such that work is not easy in itself, several times are required, and a large number of ⊂-shaped iron pins are removed and driven again in replacing the air pillar so that maintenance is difficult.

In the meanwhile, rotary inflatable signboards in which air pillars are rotated has been introduced for maximizing eyes concentration effect. Korean Laid-Open Patent Publication No. 10-2006-0029373 entitled “Rotation type air signboard”. FIG. 2 schematically shows a structure of the rotation type inflatable signboard.

Referring to FIG. 2, according to a conventional inflatable signboard, a ring-shaped rotating ring 3 is supported by a roller 5 on upper parts of the support 1 to be rotatably mounted, and such rotating ring 3 is engaged with a gear 4a mounted in an output shaft to be rotated by rotation of a motor 4.

The rotating ring 3 is coupled to the inflatable pillar (not shown). If the motor 4 is rotated, the rotating ring 3 is rotated, and accordingly, the inflatable pillar is rotated.

In the rotation type inflatable signboard, however, there are disadvantages in that additional motor for rotation is required, and noise is much because rotator power of the motor is transferred through electric means like gears.

Furthermore, when the inflatable pillar is stuck with external factors to be loaded, the motor is continuously rotated. Therefore, the gears can be damaged and load occurs in the motor. In specifically, in case that the motor is overheated by load, there is a high possibility of fire outbreak.

### SUMMARY

Accordingly, the present invention is to address the above-mentioned problems and/or disadvantages and to offer at least the advantages described below. An aspect of the present invention is to provide an inflatable signboard. Particularly, one aspect of the present invention is to provide an inflatable signboard capable of easily coupling an inflatable pillar, and the inflatable signboard includes a support which is put on the ground, and a coupling bar which is a coupling medium positioned between the support and an inflatable pillar erected on an upper part of the support, wherein a pillar insertion groove into which the inflatable pillar is capable of being inserted is formed on an upper surface of the coupling bar, a gap of the pillar insertion groove is filled with a filling lath, and the coupling bar, the filling lath, and the inflatable pillar are penetrated and fixed simultaneously through a plurality of fixing pieces, thereby coupling the inflatable pillar easily.

Another aspect of the present invention is to provide an inflatable signboard capable of easily coupling an inflatable pillar. In case that the inflatable signboard is formed in rotation type, the inflatable pillar is rotated by air sent from a blower so that it is possible to reduce noise. Also, malfunction can be avoided when load occurs.

Embodiments of the present invention provide inflatable signboard capable of easily coupling an inflatable pillar comprising a support configured to be put on the ground and have a blower for inhaling air from a lower part to send it to an upper part and an inflatable pillar configured to be made of flexible materials, formed with a tube-type, expanded with a pillar-shaped by air pressure inflowed by the blower, and erected on the upper part of the support, wherein a coupling bar is further included, wherein a lower part of the coupling bar is coupled to the support and an upper part of the coupling bar is coupled to the inflatable pillar for mutual combination. In this case, the coupling bar includes a pillar insertion groove for maintaining a predetermined gap on an upper surface of the coupling bar and encircled a circumference of a lower part of the inflatable pillar to be caved therein, a filling lath for filling a gap of the pillar insertion groove under the condition that the lower part of the inflatable pillar is inserted into the pillar insertion groove, and a plurality of fixing pieces for penetrating the filling lath and the lower part of the inflatable pillar from an outer surface of the coupling bar to be fixed in the coupling bar.

In some embodiments of the present invention, the coupling bar includes a fixing frame safely arrived on the support with a ring strip-shaped having a predetermined width to fixed to the support, a rotating frame having a lower cover and an upper cover, wherein the lower cover is guided by the fixing frame and the pillar insertion groove is formed on an upper surface of the upper cover, and the upper and lower covers are mutually combined in up and down direction across the fixing frame, and wherein a rotating module for the rotating frame is further included.

In some embodiments of the present invention, the fixing frame includes a turning roller which encircles a circumference of a friction surface between the fixing frame and the rotating frame to be formed in a predetermined interval. In this case, the rotating frame includes a ring gear which is formed in ring strip-shaped having a predetermined width to correspond to the fixing frame and has a plurality of saw-teeth encircling inner circumference to be protruded toward a center direction. In this case, the rotating module includes an impeller for being rotated by air flow sent from the blower, a speed reducing gear train for being fixed to the support and reducing a rotation of the impeller input to an input shaft to transfer it to an output shaft, and a driving gear for being connected to the output shaft of the speed reducing gear train to be rotated and engaging with the saw-teeth of the ring gear to rotate the rotating frame.

In some embodiments of the present invention, the lower cover includes a lower strip plate for rubbing with a lower surface of the fixing frame and supports the fixing frame, and a guide band for being formed in ring-strip shaped to encircle an outer surface of the fixing frame and being protruded toward the upper part of the lower cover with encircling the lower strip plate. In this case, the upper cover has a guide band insertion groove which is caved to be inserted into and coupled to the guide band at a position neighboring the pillar insertion groove on a lower surface of the upper cover. In this case, the fixing piece penetrates the filling lath inserted into the pillar insertion groove from the outer surface of the upper cover and the lower part of the inflatable pillar to be coupled to the guide band of the lower cover inserted into the guide band insertion groove, thereby fixing the upper cover, the filling lath, the inflatable pillar, and the lower cover in one body.

As above mentioned, an inflatable signboard according to the present invention, an inflatable signboard capable of easily coupling an inflatable pillar, and the inflatable signboard includes a support which is put on the ground, and a coupling bar which is a coupling medium positioned between the support and an inflatable pillar erected on an upper part of the support, wherein a pillar insertion groove into which the inflatable pillar is capable of being inserted is formed on an upper surface of the coupling bar, a gap of the pillar insertion groove is filled with a filling lath, and the coupling bar, the filling lath, and the inflatable pillar are penetrated and fixed simultaneously through a plurality of fixing pieces, thereby coupling the inflatable pillar easily. As a result, efforts and time to manufacture the inflatable signboard can be reduced, and maintenance can be easily performed when the inflatable signboard is replaced.

Also, in case that the inflatable signboard is formed in rotation type, the inflatable pillar is rotated by air sent from a blower so that it is possible to reduce noise. Also, malfunction can be avoided when load occurs.

### BRIEF DESCRIPTION OF THE DRAWINGS

FIG. 1 is a perspective view showing an example of a conventional inflatable signboard.

FIG. 2 is a conceptual section view showing a structure of a conventional rotary inflatable signboard.

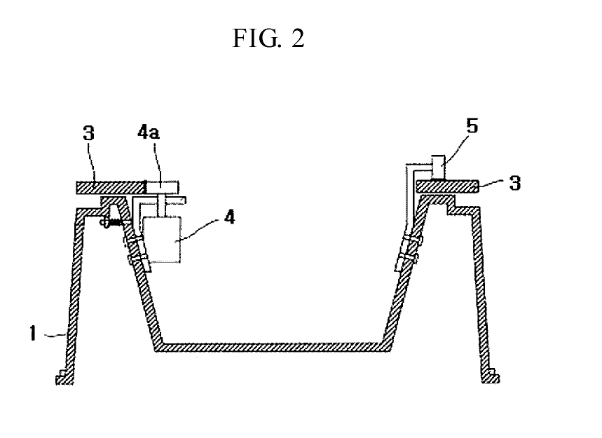

FIG. 3 is an exploded perspective view illustrating an inflatable signboard capable of easily coupling an inflatable pillar in accordance with an embodiment of the present invention.

FIG. 4 is an exploded section view illustrating an inflatable signboard capable of easily coupling an inflatable pillar in accordance with an embodiment of the present invention.

FIG. 5 is a combined section view illustrating an inflatable signboard capable of easily coupling an inflatable pillar in accordance with an embodiment of the present invention.

### DETAILED DESCRIPTION

Exemplary, non-limiting embodiments of the present invention will now be described more fully with reference to the accompanying drawings.

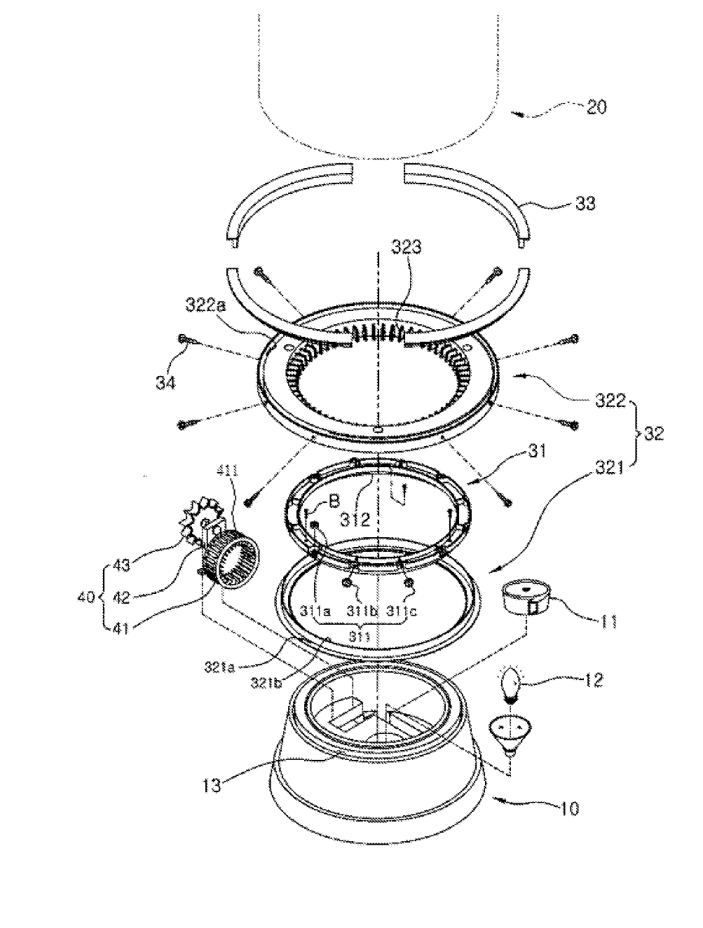

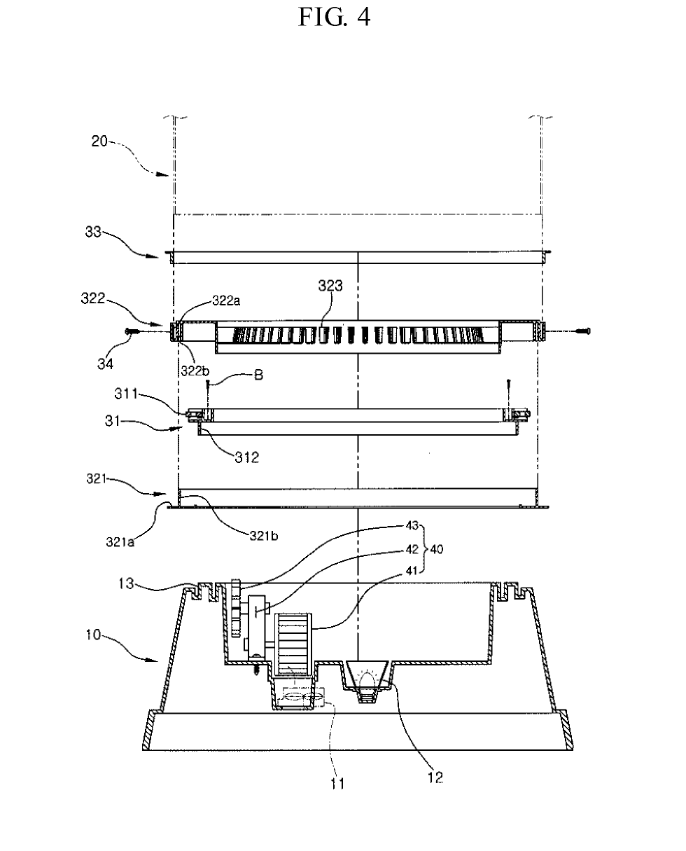

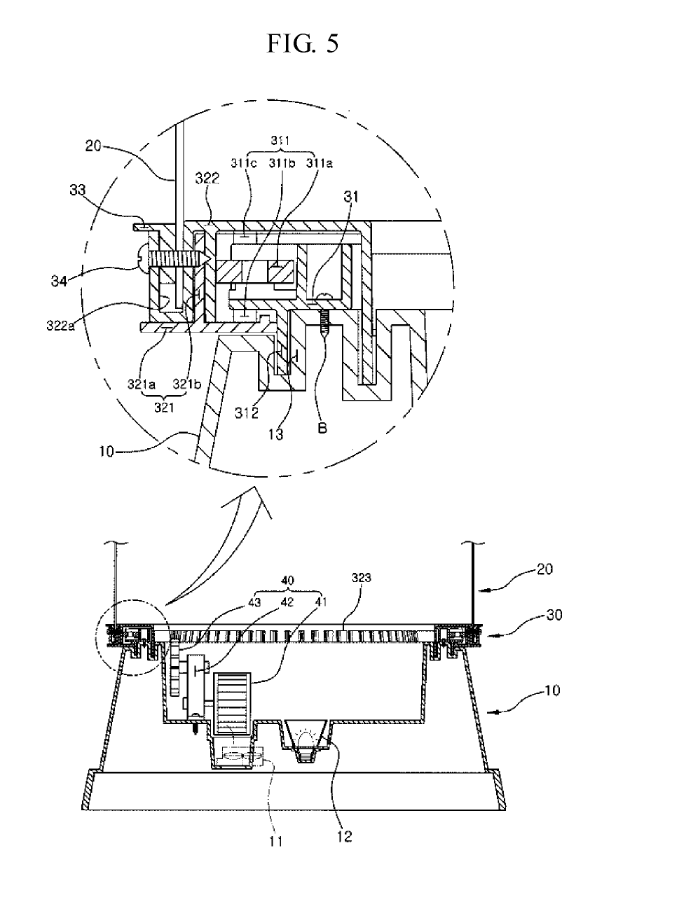

FIG. 3 is an exploded perspective view illustrating an inflatable signboard capable of easily coupling an inflatable pillar in accordance with an embodiment of the present invention. FIGS. 4 and 5 are exploded section view and combined section view illustrating an inflatable signboard capable of easily coupling an inflatable pillar in accordance with an embodiment of the present invention.

As shown in FIGS. 3 to 5, the inflatable signboard according to an embodiment of the present invention includes a support 10, an inflatable pillar 20, a coupling bar 30, and a rotating module 40.

The support 10 is constituted to support the inflatable pillar 20 that is put on the ground. An upper part of the support 10 is coupled to the coupling bar 30. In the support 10, a blower 11 for inhaling air from a lower part to send it to an upper part, a lighting 12 for irradiating light into the inflatable pillar 20, and the rotating module 40 are mounted.

As shown in FIG. 3, a projection feature 13 for inserting a feature seating band 312 formed on a lower part of a fixing frame 31 is formed as an element of the support 30 on an upper surface of the support 10. Under the condition that the feature seating band 312 of the fixing frame 31 is inserted into the projection feature 13, the fixing frame 31 and the support 10 are mutually coupled by a coupling unit such as a fixing bolt B.

The inflatable pillar 20 performs a function to display advertisement contents on its surface. The inflatable pillar 20 is made of flexible materials and formed in a tube type. The inflatable pillar 20 becomes expanded with a pillar-shaped by air pressure inflowed by the blower 11 and erected on the upper part of the support 10. In an embodiment of the present invention, a lower part of the inflatable pillar 20 is coupled to the upper part of the coupling bar 30.

The coupling bar 30 is a medium for mutually coupling the support 10 and the inflatable pillar 20. A lower part of the coupling bar 30 is coupled to the support 10, and an upper part of the coupling bar 30 is coupled to the inflatable pillar 20. In an embodiment of the present invention, in order that the inflatable pillar 20 can be formed in rotation type, the fixing frame 31 and a rotating frame 32 are formed separately, and a filling lath 33 and a fixing piece 34 are included.

The fixing frame 31 is formed in a ring-strip shape having a predetermined width and seated to be fixed to the support 10. In a lower direction of the fixing frame 31, the feature seating band 312 is protruded in order that the fixing frame 31 is seated when inserted into the projection feature 13 which is formed on an upper surface of the support 10. When the feature seating band 312 of the fixing frame 31 is inserted into the projection feature 13, the fixing frame 31 and the support 10 are mutually coupled by a coupling unit such as the fixing bolt B.

In addition, the fixing frame 31 includes a turning roller 311, which encircles a friction surface between the fixing frame 31 and the rotating frame 32 and formed in a predetermined interval. In an embodiment of the present invention, as shown in FIG. 3, since an outer surface, a lower surface, an upper surface of the fixing frame 31 is rubbed with the rotating frame 32, respectively, an outer turning roller 311a, a lower turning roller 311b, and an upper turning roller 311c sequentially encircles a circumference of the fixing frame 31 to be equipped.

The rotating frame 32 is guided by the fixing frame 31 and includes a lower cover 321 and an upper cover 322, which are mutually coupled toward up and down direction across the fixing frame 31 to be rotated on the fixing frame 31. Also, the rotating frame 32 includes a ring gear 323 which is formed in ring strip-shaped having a predetermined width to correspond to the fixing frame 31 and has a plurality of saw-teeth encircling inner circumference of the upper cover 322 to be protruded toward a center direction.

The lower cover 321 includes a lower strip plate 321a for rubbing with a lower surface of the fixing frame 31 and supports the lower part of the fixing frame 31, and a guide band 321b for being formed in ring-strip shaped to encircle an outer surface of the fixing frame 31 and being protruded toward the upper part of the lower cover 321 with encircling the lower strip plate. The lower strip plate 321a is slidly rubbed with the lower turning roller 311b of the fixing frame 31. The guide band 321b is inserted into a guide band insertion groove 322b formed on the upper cover 322 and coupled to the upper cover 322.

The upper cover 322 is guided by the fixing frame 31 with making a pair with the lower cover 321. Also, the upper cover 322 is rotated on the fixing frame 31 and coupled to the inflatable pillar 20. A pillar insertion groove 322a and the guide band insertion groove 322b are formed, and the ring gear 323 is included.

The pillar insertion groove 322a maintains a predetermined gap (t) on an upper surface of the upper cover 322 and encircles a circumference of the lower part of the inflatable pillar 20 to be caved therein. Under the condition that the lower part of the inflatable pillar 20 is inserted into the pillar insertion groove 322a, the filling lath 33 filling the gap (t) of the pillar insertion groove 322a is inserted so that the lower part of the inflatable pillar 20 is supported.

The guide band insertion groove 322b is caved in a shape in which the guide band 321b can be inserted and coupled on the lower surface of the upper cover 322 at a position neighboring the pillar insertion groove 322a. By inserting the guide band 321b into the guide band insertion groove 322b, the lower cover 321 and the upper cover 322 are coupled across the fixing frame 31.

The ring gear 323 has a plurality of saw-teeth encircling inner circumference of the upper cover 322 to be protruded toward a center direction. The rotating frame 32 is rotated by engaging the ring gear 323 with a driving gear 43 of the rotating module 40.

The filling lath 33 fills the gap (t) of the pillar insertion groove 322a under the condition that the lower part of the inflatable pillar 20 is inserted into the pillar insertion groove 322a, so that the lower part of the inflatable pillar 20 is supported by the upper cover 322. In an embodiment of the present invention, units divided by four is combined for convenience of installation and the filling lath 33 can be inserted into the gap (t) of the pillar insertion groove 322a.

A plurality of fixing pieces 34 penetrates lower parts of the filling lath 33 and the inflatable pillar 20 from the outer surface of the coupling bar 30 to be fixed in the coupling bar 30. In an embodiment of the present invention, the fixing pieces 34 penetrates the lower parts of the filling lath 33 and the inflatable pillar 20, which are inserted into the pillar insertion groove 322a from the outer surface of the upper cover 322 and then are coupled to the guide band 321b of the lower cover 321 which is inserted into the guide band groove 322b. Accordingly, the upper cover 322, the filling lath 33, the inflatable pillar 20, and the lower cover 321 are fixed in one body.

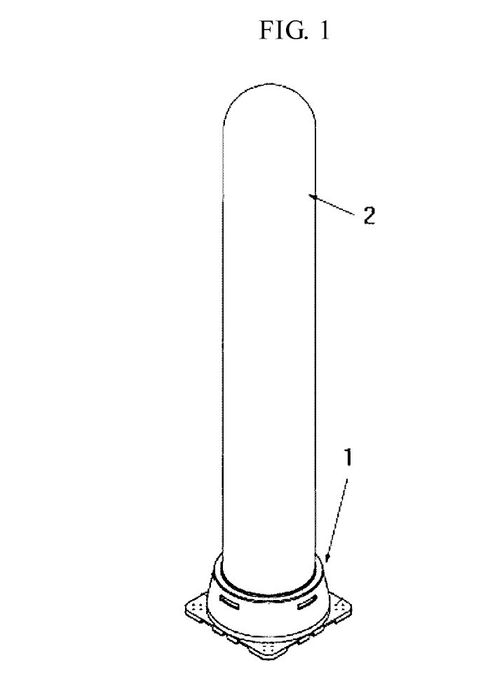

In a conventional art, as shown in FIG. 1, several ⊂-shaped iron pins should be driven at narrow interval in order to firmly fix an inflatable pillar 2 to a support 2. As a result, there are disadvantages such that work is not easy in itself, several times are required, and a large number of ⊂-shaped iron pins are removed and driven again in replacing the inflatable pillar so that maintenance is difficult. In an embodiment of the present invention, due to organic combination of the pillar insertion groove 322a and the fixing piece 34, the inflatable pillar 20 can be firmly coupled though the fixing pieces 34 are included as many as the number of divided filling lathes 33. In an embodiment of the present invention, the fixing pieces 34 may be included two times of the divided filling lathes to be respectively coupled at both sides of the divided filling lathes 33.

The rotating module 40 is mounted in the support 10 to rotate the rotating frame 32 and includes an impeller 41, a speed reducing gear train 42, and the driving gear 43.

The impeller 41 is rotated by air flow sent by the blower 11. A multiplicity of blades 411 of the impeller 41 impacting with air is mounted slantly. In other words, the impeller 41 is rotated by air flow that impacts with the blades 411. These constructions are used in various fields such as a windmill and accordingly, its description has been omitted here

Of course, an air guidance (not shown) may be formed in the support 10 to smoothly introduce air flow sent from the blower 11 to the impeller 41.

Unlike a conventional art, the embodiment of the present invention may not use a rotary motor, and the impeller 41 is rotated by air sent by the blower 11. For this reason, noise can be reduced, and malfunction can be avoided when load occurs.

The speed reducing gear train 42 reduces a rotation of the impeller 41 input to an input shaft with fixing on the support 10.

That is, the input shaft of the speed reducing gear train 42 is coupled to the impeller 41, and an output shaft of the speed reducing gear train 42 is coupled to the driving gear 43, thereby controlling a rotation speed of the inflatable pillar 20 as well as reducing load required to rotate the inflatable pillar 20. Resultantly, the impeller can be sufficiently rotated by air sent from the blower 11.

The driving gear 43 is coupled to the output shaft of the speed reducing gear train 42 to be rotated. The driving gear 43 is engaged with saw-teeth of the ring gear 323 to rotate the rotating frame 32, and thereby rotating the inflatable pillar 20.

Meanwhile, the ring gear 323 and the driving gear 43 are engaged through bevel gear manner in which rotating shafts are at right angles to each other in an embodiment of the present invention.

As described above, the present invention provides an inflatable signboard having coupling bar as a coupling medium of a support and an inflatable pillar to easily couple an inflatable pillar.

While this invention has been particularly shown and described with reference to an exemplary embodiment thereof, it will be understood by those skilled in the art that various changes in form and details may be made therein without departing from the spirit and scope of the invention as defined by the appended claims.

1. An air inflatable signboard, comprising:
a support to be put on the ground and have a blower for inhaling air from a lower part to send it to an upper part; and
an inflatable pillar comprised of flexible materials, the inflatable pillar erected on the upper part of the support by the air inflowed by the blower;
a coupling bar having a lower part and an upper part, wherein the lower part of the coupling bar is coupled to the support and the upper part of the coupling bar is coupled to the inflatable pillar for combination of the support and the inflatable pillar,
the coupling bar comprising:
a pillar insertion groove at a position of an upper surface of the coupling bar corresponding to a lower part of the inflatable pillar;
a filling lath for filling a gap of the pillar insertion groove under the condition that the lower part of the inflatable pillar is inserted into the pillar insertion groove; and
a plurality of fixing pieces for penetrating the filling lath and the lower part of the inflatable pillar from an outer surface of the coupling bar to be fixed in the coupling bar.

2. The inflatable signboard of claim 1, wherein the coupling bar further comprises:
a fixing frame received on the support, the fixing frame having a shape of a ring strip having a predetermined width to be fixed to the support;
a rotating frame having a lower cover and an upper cover, wherein the lower cover is guided by the fixing frame and the pillar insertion groove is formed on an upper surface of the upper cover, and the upper and lower covers are mutually combined in up and down direction across the fixing frame; and
a rotating module to rotate the rotating frame.

3. The inflatable signboard of claim 2, wherein the fixing frame includes a turning roller which encircles a circumference of a friction surface between the fixing frame and the rotating frame to be formed in a predetermined interval; and
the rotating frame includes a ring gear formed in a shape of a ring strip having a predetermined width to correspond to the fixing frame, and the ring gear has a plurality of saw-teeth encircling inner circumference to be protruded toward a center direction, and
the rotating module includes:
an impeller for being rotated by air flow sent from the blower;
a speed reducing gear train for being fixed to the support and reducing a rotation speed of the impeller while transferring the rotation of the impeller received from an input shaft of the speed reducing gear to an output shaft of the speed reducing gear; and
a driving gear connected to the output shaft of the speed reducing gear train to be rotated and engaging with the saw-teeth of the ring gear to rotate the rotating frame.

4. The inflatable signboard of claim 2, wherein the lower cover includes:
a lower strip plate for rubbing against a lower surface of the fixing frame and supporting the lower part of the fixing frame; and
a guide band formed in a shape of a ring strip to encircle an outer surface of the fixing frame and protruded toward the upper part of the lower cover with encircling the lower strip plate;
wherein the upper cover has a guide band insertion groove to receive the guide band at a position neighboring the pillar insertion groove on a lower surface of the upper cover; and
the fixing piece penetrates the filling lath inserted into the pillar insertion groove from the outer surface of the upper cover and the lower part of the inflatable pillar to be coupled to the guide band of the lower cover inserted into the guide band insertion groove, thereby fixing the upper cover, the filling lath, the inflatable pillar, and the lower cover in one body.

5. The inflatable signboard of claim 1, wherein the inflatable pillar is formed with a tube-type.

6. The inflatable signboard of claim 3, wherein the lower cover includes:
a lower strip plate for rubbing against a lower surface of the fixing frame and supporting the lower part of the fixing frame; and
a guide band formed in a shape of a ring strip to encircle an outer surface of the fixing frame and protruded toward the upper part of the lower cover with encircling the lower strip plate;
wherein the upper cover has a guide band insertion groove to receive the guide band at a position neighboring the pillar insertion groove on a lower surface of the upper cover; and
the fixing piece penetrates the filling lath inserted into the pillar insertion groove from the outer surface of the upper cover and the lower part of the inflatable pillar to be coupled to the guide band of the lower cover inserted into the guide band insertion groove, thereby fixing the upper cover, the filling lath, the inflatable pillar, and the lower cover in one body.

7. An inflatable signboard, comprising:
a support to be put on the ground and have a blower for inhaling air from a lower part to send it to an upper part;
an inflatable pillar comprised of flexible materials, the inflatable pillar erected on the upper part of the support by the air inflowed by the blower;
a coupling bar having a lower part and an upper part, wherein the lower part of the coupling bar is coupled to the support and the upper part of the coupling bar is coupled to the inflatable pillar for combination of the support and the inflatable pillar, the coupling bar comprising:
a pillar insertion groove at a position of an upper surface of the coupling bar corresponding to a lower part of the inflatable pillar;
a filling lath for filling a gap of the pillar insertion groove under the condition that the lower part of the inflatable pillar is inserted into the pillar insertion groove;
a plurality of fixing pieces for penetrating the filling lath and the lower part of the inflatable pillar from an outer surface of the coupling bar to be fixed in the coupling bar;
a fixing frame received on the support, the fixing frame having a shape of a ring strip having a predetermined width to be fixed to the support, the fixing frame comprising a turning roller which encircles a circumference of a friction surface between the fixing frame and the rotating frame to be formed in a predetermined interval;
a rotating frame having a lower cover and an upper cover, wherein the lower cover is guided by the fixing frame and the pillar insertion groove is formed on an upper surface of the upper cover, and the upper and lower covers are mutually combined in up and down direction across the fixing frame; and
a rotating module to rotate the rotating frame.

8. The inflatable signboard of claim 7, wherein the rotating frame includes a ring gear formed in a shape of a ring strip having a predetermined width to correspond to the fixing frame, and the ring gear has a plurality of saw-teeth encircling inner circumference to be protruded toward a center direction.

9. The inflatable signboard of claim 8, wherein the rotating module comprises:
an impeller for being rotated by air flow sent from the blower;
a speed reducing gear train for being fixed to the support and reducing a rotation speed of the impeller while transferring the rotation of the impeller received from an input shaft of the speed reducing gear to an output shaft of the speed reducing gear; and
a driving gear connected to the output shaft of the speed reducing gear train to be rotated and engaging with the saw-teeth of the ring gear to rotate the rotating frame.

10. The inflatable signboard of claim 7, wherein the lower cover comprises:
a lower strip plate for rubbing against a lower surface of the fixing frame and supporting the lower part of the fixing frame; and
a guide band formed in a shape of a ring strip to encircle an outer surface of the fixing frame and protruded toward the upper part of the lower cover with encircling the lower strip plate.

11. The inflatable signboard of claim 10, wherein the upper cover has a guide band insertion groove to receive the guide band at a position neighboring the pillar insertion groove on a lower surface of the upper cover; and
the fixing piece penetrates the filling lath inserted into the pillar insertion groove from the outer surface of the upper cover and the lower part of the inflatable pillar to be coupled to the guide band of the lower cover inserted into the guide band insertion groove, thereby fixing the upper cover, the filling lath, the inflatable pillar, and the lower cover to each other.
